(19) United States
(12) Patent Application Publication
(10) Pub. No.: US 2013/0049853 A1
(43) Pub. Date: Feb. 28, 2013

(54) SUPPRESSION OF OVERVOLTAGE CAUSED BY AN INDIRECT LIGHTNING STRIKE

(71) Applicants: Dieter Selos, Maria Enzersdorf Sudstadt (AT); Wolfgang Dittrich, Wien (AT)

(72) Inventors: Dieter Selos, Maria Enzersdorf Sudstadt (AT); Wolfgang Dittrich, Wien (AT)

(73) Assignee: FTS COMPUTERTECHNIK GMBH, Wien (AT)

(21) Appl. No.: 13/579,503

(22) PCT Filed: Feb. 17, 2011
(86) PCT No.: PCT/AT11/00082

§ 371 Date: Nov. 15, 2012

(30) Foreign Application Priority Data
Feb. 17, 2010 (AT) A 239/2010

(51) Int. Cl. H04B 3/30

(52) U.S. Cl. 327/594

(57) ABSTRACT

A coupling circuit for a bus subscriber on a bus line of a field bus with DC-voltage-free and differential EIA-485/EIA-422-compliant signal transmission according to a TTP protocol, in which the two inputs/outputs of a transmission/reception component of the bus subscriber are connected to a first winding of a signal transformer, and the two poles of the bus line are connected to a second winding of the signal transformer, and the first winding has a center tap, wherein the center tap is connected to the local reference-earth potential of the bus subscriber via a capacitor, the capacitance of which is at least 100 times the parasitic capacitance of the transformer.

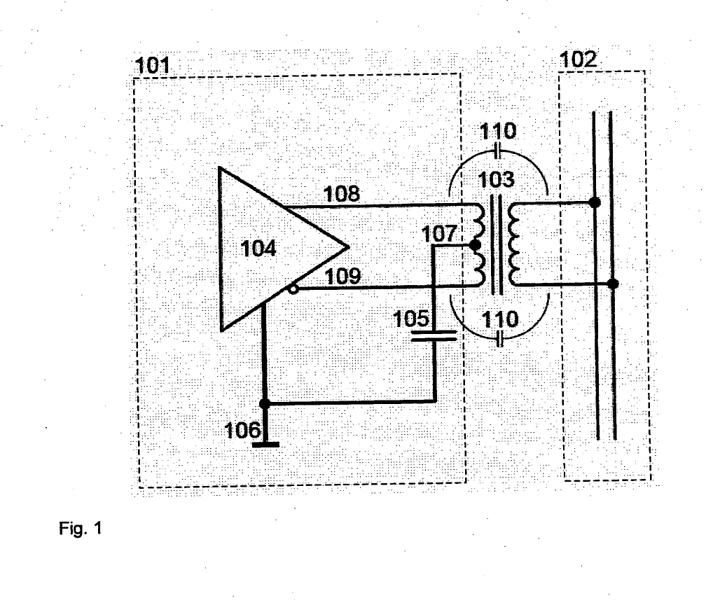

The invention relates to a coupling circuit for a bus subscriber on a bus line of a field bus with DC-voltage-free and differential EIA-485/EIA-422-compliant signal transmission according to a TTP protocol, in which the two inputs/outputs of a transmission/reception component of the bus subscriber are connected to a first winding of a signal transformer, and the two poles of the bus line are connected to a second winding of the signal transformer.

For galvanic isolation, inductive bus couplers use a signal transformer which acts as galvanic isolation between data bus and bus subscriber. Through this, potential differences between the bus subscribers as well as between the bus subscribers and the bus line are permissible. Considering the properties of real signal transformers in contrast to theoretically ideal transformers, dynamic interferences occur at least partially due to the capacitive coupling between the transformer windings. Such cross-coupling interferences can results in transmission errors or can cause permanent damage to the connected components. Therefore, where applicable, a suitable protective circuit has to suppress these interferences in a sufficient manner. In particular in safety-critical applications, such as signal transmission to field busses in the aviation sector, especially transient common-mode interferences caused by indirect lightning strike can result in transmission errors or can cause destruction of the components and can often be the starting point of catastrophic malfunctions of the overall system. Common-mode interferences, caused by indirect lightning, can occur between reference (earth) potentials of the bus subscribers and are often referred to as “ground offset”, or they can occur by coupling into the differential bus line.

In the case of interferences by indirect lightning strike, based on experience, low internal resistance of the interference source can be assumed. If the capacitor for interference suppression is located on the incoming side of the transformer, as implemented for the so-called “Bob Smith termination”, the interference voltage, which can have values in the kV range, can be reduced through dissipation via the capacitor only to an insignificant extent. Also, an essential disadvantage is that, in addition, a very high interference current occurs which can cause permanent damage to the components or can completely destroy the components.

It is an object of the invention to suppress such interferences on the side of the bus subscribers to a safe level without impairing the signal quality.

This object is achieved with a coupling circuit of the aforementioned kind, in which, according to the invention, the first winding has a center tap which is connected to the local reference potential of the bus subscriber via a capacitor, the capacitance of which is at least 100 times the parasitic capacitance of the transformer.

Owing to the invention, crosstalking interferences on the side of the bus subscribers are suppressed. Suppressing takes place in a manner that common-mode interferences are suppressed, but the push-pull useful signal is not subject to attenuation. The capacitive connection of the center tap to a local reference potential is useful if connected components superimpose direct current voltage on the differential useful signal.

Since the capacitor for interference suppression is located on the isolated side, also, the parasitic coupling capacitance of the transformer acts in addition to the low internal resistance of the interference source. Only because of this is it possible, on the one hand, to significantly reduce the interference voltage and, on the other, that only a low current flow occurs because the parasitic coupling capacitance is in the pF range and therefore limits current to values which no longer result in destruction of components.

It has proven in practice to be advantageous if the capacitance of the capacitor is 5 to 500 nF.

In order to achieve a preferably low-resistance connection to the reference (earth) potential, it is useful if the signal transformer is arranged in the vicinity of the transmission/reception component of the bus subscriber.

Furthermore, it advantageous if the local reference potential corresponds to the common ground; however, it can also be provided that the local reference potential corresponds to a pole of a supply voltage because also the poles of the supply voltage have a fixed capacitive coupling to ground.

The invention including further advantages is explained in more detail hereinafter with reference to the drawing in which the sole figure shows a coupling circuit for a bus subscriber on a bus line.

By means of the Figure, an implementation of the coupling circuit based on a data bus with EIA-485 or EIA-422-compliant signal transmission is now described.

A bus subscriber 101 is coupled to a bus line 102 by means of a signal transformer 103. The bus subscriber 101 has a transmission/reception component 104 of which, for reasons of simplification, only the reception component is illustrated, and a local reference-earth potential 106, in this example, a ground.

The connections 108, 109, namely the input connections of the transmission/reception component 104 of the bus subscriber 101, are connected to a first winding of a signal transformer 103, and the two poles of a bus line 102 are connected to a second winding of this signal transformer. The first winding of the transformer 103 has a center tap 107 which is connected to the reference-earth potential 106 via a capacitor 105.

A direct coupling of the center tap 107 to the local reference-earth potential 106 is not possible for typical EIA-485 or EIA-422-compliant transmission/reception components 104 because the connections 108 and 109 are superimposed with a direct current voltage.

In a practical configuration, the signal transformer 103 and the bus subscriber 101 are mounted in a common housing or also on a common circuit board because it is recommended to arrange the transformer as close as possible to the transmission/reception component 104 so as to achieve a connection to the reference-earth potential 106, which connection has an ohmic resistance as low as possible.

Through the bypass capacitor 105, the coupling circuit according to the invention acts against dynamic common-mode interferences in the form of a potential difference between the bus subscriber 101 and the bus line 102, and the transmission/reception component 104 is protected against overvoltage at the connections 108 and 109 with respect to the local reference-earth potential 106.

Below, the exact operation principle of the circuit according to the invention is explained. In particular interferences, caused by indirect lightning strike, in the form of dynamic potential differences between the bus subscriber 101 and the bus line 102 effect a current flow through the parasitic coupling capacitance 110 of the signal transformer 103. Without the capacitor 105, this current flow would cause at the high-impedance connections 108 and 109 of the transmission/reception component 104 a high interference voltage against the local reference-earth potential 106. By using a capacitor 105, the cross-coupling interference current does not flow in or out of the connections 108 and 109 of the transmission/reception component 104, but almost exclusively through the bus-subscriber-side winding of the signal transformer 103 and subsequently via the capacitor 105 against the local reference-earth potential 106. The interference currents through the signal transformer winding run in the opposite direction so that no magnetic field is formed. Thus, mainly the ohmic conductor resistances act in the transformer winding, and only a small inductive resistance proportion due to leakage inductances or asymmetries in windings or current flow.

The degree of achievable interference suppression is calculated in approximation through the division ratio of the parasitic capacitance 110 of the transformer 103 and the one of the capacitor 105 as follows:

$$\frac{{U}_{Int}}{{U}_{R}} = 1 + \frac{{C}_{A}}{{C}_{K}}$$

### Wherein:

U_{Int}=Interference voltage between bus subscriber 101 and bus line 102.
U_{R}=Residual voltage at the inputs 108 and 109 against the reference-earth potential 106.
C_{A}=Capacitance of the capacitor 105.
C_{K}=Parasitic capacitance 110.

The parasitic capacitance of signal transformers typically ranges from 10 pF to 50 pF. With a capacitance of the capacitor of, e.g., 47 nF, the calculation according to the formula above results in an interference suppression of approximately 1000 to 5000. Practical experience has shown that for logical reasons, the capacitance should be at least 100 times the parasitic capacitance 110 of the transformer 103. Typical values of the capacitance of the capacitor 105 range between 5 to 500 nF.

The DC-voltage-free differentially transmitted useful signal is not subject to an additional attenuation through the bypass capacitor 105 because for differential signals, no current flows through the capacitor 105.

1. A coupling circuit for a bus subscriber on a bus line of a field bus with DC-voltage-free and differential EIA-485/EIA-422-compliant signal transmission according to a TTP protocol, in which the two inputs/outputs of a transmission/reception component of the bus subscriber are connected to a first winding of a signal transformer, and the two poles of the bus line are connected to a second winding of the signal transformer,
wherein the first winding has a center tap which is connected to the local reference potential of the bus subscriber via a capacitor, the capacitance of which is at least 100 times the parasitic capacitance of the transformer.

2. The coupling circuit according to claim 1, wherein the capacitance of the capacitor is 5 to 500 nF.

3. The coupling circuit according to claim 1, wherein characterized in that the local reference potential corresponds to the common ground.

4. The coupling circuit according to claim 1, wherein the local reference potential corresponds to a pole of a supply voltage.

5. The coupling circuit according to claim 1, wherein the signal transformer is arranged in the vicinity of the transmission/reception component of the bus subscriber.
